(19) United States
(12) Patent Application Publication
(10) Pub. No.: US 2026/0131814 A1
(43) Pub. Date: May 14, 2026

(54) ALERT DEVICE

(71) Applicant: TOYOTA JIDOSHA KABUSHIKI KAISHA, Toyota-shi (JP)

(72) Inventor: Atsushi ISHII, Toyota-shi (JP)

(73) Assignee: TOYOTA JIDOSHA KABUSHIKI KAISHA, Toyota-shi (JP)

(21) Appl. No.: 19/362,764

(22) Filed: Oct. 20, 2025

(30) Foreign Application Priority Data
Nov. 11, 2024 (JP) 2024-196583

(51) Int. Cl. B60W 50/14; B60W 40/08; G06V 20/58; G06V 20/59; G06V 40/16

(52) U.S. Cl. CPC B60W 50/14; B60W 40/08; G06V 20/582; G06V 20/584; G06V 20/597; G06V 40/172; B60W 2040/0809; B60W 2050/143; B60W 2050/146; B60W 2420/403; B60W 2520/10; B60W 2540/043; B60W 2555/60; G06V 2201/07

(57) ABSTRACT

An alert device issues an alert to a driver of a vehicle that the vehicle needs to be stopped. The alert device includes a camera and a target recognition unit that detect at least one of a stop sign and a red light or a yellow light of a traffic light present in a traveling direction of a vehicle, a time-series data extraction unit that acquires information related to a driving tendency of a driver with respect to the at least one of the stop sign and the red light or the yellow light of the traffic light, and an alarm controller that controls a timing of issuing an alert by using the information related to the driving tendency.

### CROSS-REFERENCE TO RELATED APPLICATION

This application claims priority to Japanese Patent Application No. 2024-196583 filed on Nov. 11, 2024. The disclosure of the above-identified application, including the specification, drawings, and claims, is incorporated by reference herein in its entirety.

### BACKGROUND

### 1. Technical Field

The present disclosure relates to an alert device.

### 2. Description of Related Art

As an alert device in a related art, for example, a technique described in Japanese Unexamined Patent Application Publication No. 2008-117131 (JP 2008-117131 A) is known. The alert device disclosed in JP 2008-117131 A is a device that issues an alert related to a stop position present in a traveling direction of a vehicle. The alert device includes a navigation device that acquires a distance between a vehicle and a stop position, a vehicle speed sensor that detects a vehicle speed of the vehicle, a road gradient identification unit that identifies a gradient of a road on which the vehicle travels, based on detection values of a G sensor and the vehicle speed sensor, and an alert determination unit that determines whether to issue an alert based on the distance between the vehicle and the stop position, the vehicle speed of the vehicle, and the gradient of the road.

### SUMMARY

In the related art, even when the vehicle or the driver is different, the alert is issued as long as the vehicle speed of the vehicle and the distance between the vehicle and the stop position are the same. However, a deceleration action of the vehicle with respect to the stop position (deceleration start timing, deceleration amount, minimum vehicle speed, and the like) varies depending on each driver of the vehicle. For this reason, some drivers may find the timing of the alert annoying.

An object of the present disclosure is to provide an alert device capable of issuing an alert without causing annoyance to a driver of a vehicle.

(1) An aspect of the present disclosure relates to an alert device that issues an alert to a driver of a vehicle that the vehicle needs to be stopped. The alert device includes a target detection unit configured to detect at least one of a stop sign and a red light or a yellow light of a traffic light present in a traveling direction of the vehicle, an acquisition unit configured to acquire information related to a driving tendency of the driver with respect to the at least one of the stop sign and the red light or the yellow light of the traffic light detected by the target detection unit, and a controller configured to control a timing of issuing the alert by using the information related to the driving tendency acquired by the acquisition unit.

(2) In (1) described above, the alert device may further include
a distance detection unit configured to detect a distance from the vehicle to a stop line corresponding to the at least one of the stop sign and the traffic light,
a first calculation unit configured to calculate a parameter related to a traveling state of the vehicle when the vehicle is being brought to a stop at the stop line, based on the information related to the driving tendency acquired by the acquisition unit,
a second calculation unit configured to calculate an alert operation distance with respect to the stop line based on the parameter related to the traveling state of the vehicle calculated by the first calculation unit, and
a determination unit configured to determine whether the distance to the stop line detected by the distance detection unit is equal to or shorter than the alert operation distance calculated by the second calculation unit.
The controller may perform control to issue the alert when the determination unit determines that the distance to the stop line is equal to or shorter than the alert operation distance.

(3) In (2) described above, the determination unit may determine whether the distance to the stop line is equal to or shorter than the alert operation distance and the vehicle is being decelerated, and
the controller may perform the control to issue the alert when the determination unit determines that the distance to the stop line is equal to or shorter than the alert operation distance and the vehicle is being decelerated.

(4) In (2) or (3) described above, the alert device may further include a vehicle speed detection unit configured to detect a vehicle speed of the vehicle.
The acquisition unit may acquire, as the information related to the driving tendency, time-series data of the vehicle speed detected by the vehicle speed detection unit and time-series data of the distance to the stop line that is detected by the distance detection unit. The first calculation unit may calculate, as the parameter related to the traveling state of the vehicle, a deceleration of the vehicle when the vehicle is being brought to a stop, a minimum speed of the vehicle, and an offset amount of a stop position of the vehicle with respect to the stop line.

(5) In any one of (2) to (4) described above, the alert device may further include a recognition unit configured to recognize the driver.
The second calculation unit may calculate the alert operation distance according to the driver recognized by the recognition unit.

According to the present disclosure, it is possible to issue the alert without causing annoyance to the driver of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram showing an alert device according to an embodiment of the disclosure;

FIG. 2 is a diagram showing a state in which a vehicle approaches a stop sign;

FIG. 3 is a flowchart showing a procedure of a parameter calculation process executed by an ECU shown in FIG. 1; and

FIG. 4 is a flowchart showing a procedure of the alert control process executed by the ECU shown in FIG. 1.

### DETAILED DESCRIPTION OF EMBODIMENTS

The embodiments of the present disclosure will be described in detail with reference to the drawings.

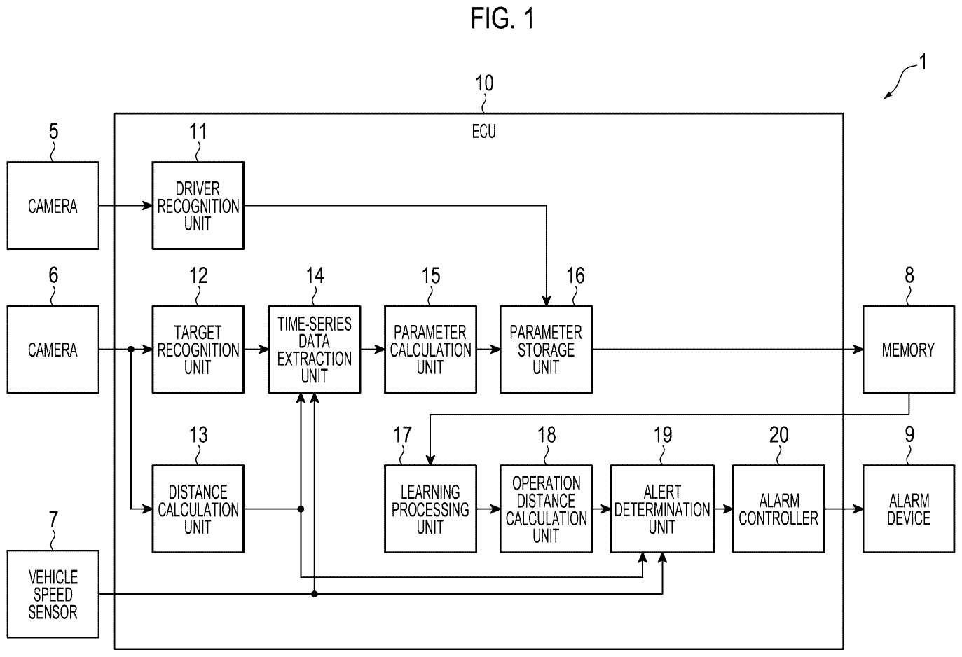

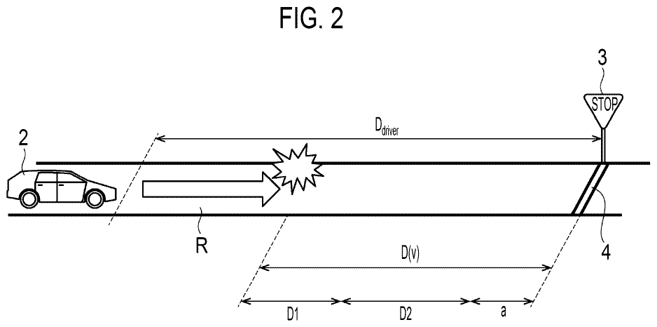

FIG. 1 is a schematic configuration diagram showing an alert device according to an embodiment of the disclosure. In FIG. 1, the alert device 1 of the present embodiment is mounted in a vehicle 2 (see FIG. 2). The alert device 1 is a device that issues an alert to the driver of the vehicle 2 that the vehicle 2 needs to be stopped.

As shown in FIG. 2, the alert device 1 issues an alert to the driver that the vehicle 2 needs to be stopped at a position in front of a stop line 4 corresponding to a stop sign 3 or a traffic light (not shown) on a road R on which the stop sign 3 or the traffic light is installed.

The alert device 1 includes a camera 5 for capturing a driver, a camera 6 for capturing a front, a vehicle speed sensor 7, a memory 8, an alarm device 9, and an Electronic Control Unit (ECU) 10.

The camera 5 images a face of the driver seated in a driver's seat of the vehicle 2 to acquire image data of the face of the driver. As the camera 5, for example, a monocular camera or a stereo camera is used. The camera 6 images the front of the vehicle 2 to acquire image data of the front of the vehicle 2. As the camera 6, for example, a plurality of monocular cameras or a stereo camera is used. The vehicle speed sensor 7 is a vehicle speed detection unit that detects a traveling speed (vehicle speed) of the vehicle 2.

The memory 8 stores a parameter (described later) related to the traveling state of the vehicle 2 when the vehicle 2 being brought to a stop at the stop line 4 (see FIG. 2). The memory 8 has a sufficient number of parameters related to the traveling state of the vehicle 2. The memory 8 may be built in the ECU 10. The alarm device 9 issues an alert alarm, for example, by an alarm sound and an alarm display.

The ECU 10 is configured of a CPU, a RAM, a ROM, an input and output interface, and the like. The ECU 10 loads a program recorded in, for example, the ROM into the RAM, and executes the program loaded in the RAM by the CPU.

The ECU 10 includes a driver recognition unit 11, a target recognition unit 12, a distance calculation unit 13, a time-series data extraction unit 14, a parameter calculation unit 15, a parameter storage unit 16, a learning processing unit 17, an operation distance calculation unit 18, an alert determination unit 19, and an alarm controller 20.

The driver recognition unit 11 recognizes the driver who drives the vehicle 2 based on the image data acquired by the camera 5. The driver recognition unit 11 cooperates with the camera 5 to configure a recognition unit that recognizes the driver.

The target recognition unit 12 recognizes the state of the stop sign 3 or a traffic light (not shown) present in front of the vehicle 2 based on the image data acquired by the camera 6. The target recognition unit 12 recognizes a red light or a yellow light of the traffic light as the state of the traffic light. The target recognition unit 12 cooperates with the camera 6 to configure a target detection unit that detects at least one of the stop sign 3 and the red light or the yellow light of the traffic light present in the traveling direction of the vehicle 2.

The distance calculation unit 13 calculates the distance from the vehicle 2 to the stop line 4 (see FIG. 2) corresponding to the stop sign 3 or the traffic light (not shown) based on the image data acquired by the camera 6. The distance calculation unit 13 cooperates with the camera 6 to configure a distance detection unit that detects a distance from the vehicle 2 to the stop line 4 corresponding to at least one of the stop sign 3 and the traffic light.

The time-series data extraction unit 14 extracts, based on the detection value of the vehicle speed sensor 7 and the distance from the vehicle 2 to the stop line 4 calculated by the distance calculation unit 13, time-series data of the vehicle speed of the vehicle 2 from when the vehicle 2 is decelerated to the regulated speed to when the vehicle 2 reaches the minimum speed of the vehicle 2, and time-series data of the distance from the vehicle 2 to the stop line 4 from when the vehicle 2 is decelerated to the regulated speed. The time-series data of the vehicle speed and the distance corresponds to information related to the driving tendency of the driver with respect to the stop sign 3 or the traffic light.

The time-series data extraction unit 14 configures an acquisition unit that acquires information related to the driving tendency of the driver with respect to at least one of the stop sign 3 and the red light or the yellow light of the traffic light detected by the target detection unit. The time-series data extraction unit 14 acquires time-series data of the vehicle speed detected by the vehicle speed sensor 7 (vehicle speed detection unit) and time-series data of the distance to the stop line 4 detected by the distance detection unit as the information related to the driving tendency.

The parameter calculation unit 15 calculates a parameter (hereinafter, may be referred to as a traveling parameter) related to the traveling state of the vehicle 2 when the vehicle 2 is being brought to a stop at the stop line 4 based on the time-series data of the vehicle speed and the distance extracted by the time-series data extraction unit 14. The parameter calculation unit 15 calculates, as the parameter related to the traveling state of the vehicle 2, the deceleration of the vehicle 2 when the vehicle 2 is being brought to a stop, the minimum speed of the vehicle 2, and the offset amount of the stop position of the vehicle 2 with respect to the stop line 4.

The parameter calculation unit 15 configures a first calculation unit that calculates the parameter related to the traveling state of the vehicle 2 when the vehicle 2 is being brought to a stop at the stop line 4 based on the information related to the driving tendency of the driver acquired by the acquisition unit.

The parameter storage unit 16 stores the parameter related to the traveling state of the vehicle 2 calculated by the parameter calculation unit 15 in the memory 8 in association with the driver recognized by the driver recognition unit 11. The parameter storage unit 16 stores the deceleration of the vehicle 2, the minimum speed of the vehicle 2, and the offset amount of the stop position of the vehicle 2 with respect to the stop line 4 in the memory 8 together with driver data.

The learning processing unit 17 reads the traveling parameter corresponding to the driver recognized by the driver recognition unit 11 from the memory 8 and creates the distribution of the traveling parameter to execute the learning process of the traveling parameter. The learning process will be described in detail later.

The operation distance calculation unit 18 calculates an alert operation distance D(V) with respect to the stop line 4 based on the result of learning of the learning processing unit 17. The alert operation distance D(V) is a distance needed to issue an alert to the driver of the vehicle 2 (see FIG. 2). The operation distance calculation unit 18 cooperates with the learning processing unit 17 to configure a second calculation unit that calculates the alert operation distance to the stop line 4 based on the parameter related to the traveling state of the vehicle 2 calculated by the parameter calculation unit 15 (first calculation unit).

As shown in FIG. 2, the alert determination unit 19 determines whether a distance D_{driver} to the stop line 4 calculated by the distance calculation unit 13 is equal to or shorter than the alert operation distance D(V) calculated by the operation distance calculation unit 18, and determines whether the vehicle 2 is being decelerated based on the detection value of the vehicle speed sensor 7.

The alert determination unit 19 configures a determination unit that determines whether a distance to the stop line 4 detected by the distance detection unit is equal to or shorter than the alert operation distance calculated by the second calculation unit. The alert determination unit 19 determines whether the distance to the stop line 4 is equal to or shorter than the alert operation distance and the vehicle 2 is being decelerated.

The alarm controller 20 controls the alarm device 9 to issue the alert alarm when the alert determination unit 19 determines that the distance D_{driver} to the stop line 4 is equal to or shorter than the alert operation distance D(V) and determines that the vehicle 2 is not being decelerated.

The alarm controller 20 cooperates with the alarm device 9 to configure a controller that controls a timing of issuing the alert by using the information related to the driving tendency acquired by the acquisition unit. The alarm controller 20 is configured to perform control to issue the alert when the alert determination unit 19 determines that the distance to the stop line 4 is equal to or shorter than the alert operation distance and the vehicle 2 is being decelerated.

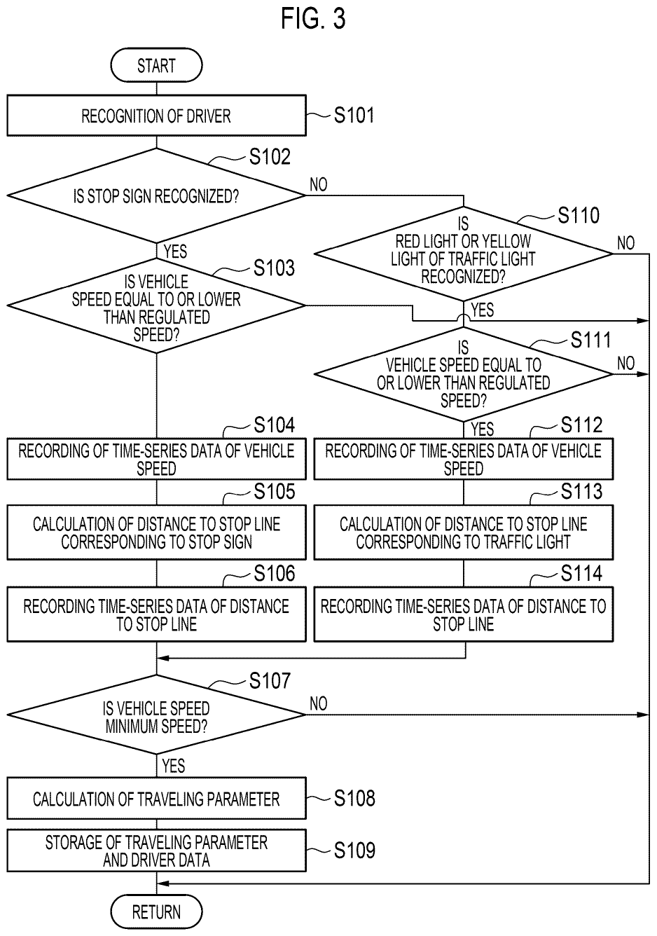

FIG. 3 is a flowchart showing a procedure of a parameter calculation process executed by the ECU 10. The present process is executed by the driver recognition unit 11, the target recognition unit 12, the distance calculation unit 13, the time-series data extraction unit 14, the parameter calculation unit 15, and the parameter storage unit 16.

In FIG. 3, the ECU 10 first recognizes the driver of the vehicle 2 based on the image data of the camera 5 (step S101). Next, the ECU 10 determines whether the stop sign 3 present in front of the vehicle 2 is recognized based on the image data of the camera 6 (step S102).

When the ECU 10 determines that the stop sign 3 present in front of the vehicle 2 is recognized, the ECU 10 determines whether the vehicle speed of the vehicle 2 is equal to or lower than the regulated speed based on the detection value of the vehicle speed sensor 7 (step S103). The regulated speed is, for example, 10 km/h. When the ECU 10 determines that the vehicle speed of the vehicle 2 is not equal to or less than the regulated speed, the ECU 10 executes step S101 again.

When the ECU 10 determines that the vehicle speed of the vehicle 2 is equal to or lower than the regulated speed, the ECU 10 records the time-series data of the vehicle speed of the vehicle 2 (step S104). Further, the ECU 10 calculates the distance from the vehicle 2 to the stop line 4 corresponding to the stop sign 3 based on the image data of the camera 6 (step S105). Then, the ECU 10 records the time-series data of the distance from the vehicle 2 to the stop line 4 corresponding to the stop sign 3 (step S106).

Next, the ECU 10 determines whether the vehicle speed of the vehicle 2 is equal to the minimum speed based on the detection value of the vehicle speed sensor 7 (step S107). Here, the minimum speed is zero. That is, the minimum speed is the speed of the vehicle 2 in the stopped state. When the ECU 10 determines that the vehicle speed of the vehicle 2 is not the minimum speed, the ECU 10 executes step S101 again.

When the ECU 10 determines that the vehicle speed of the vehicle 2 is the minimum speed, the ECU 10 calculates the three traveling parameters based on the time-series data of the vehicle speed of the vehicle 2 recorded in step S104 and the time-series data of the distance from the vehicle 2 to the stop line 4 recorded in step S106 (step S108). The traveling parameter is a deceleration of the vehicle 2, the minimum speed of the vehicle 2, and an offset amount of a stop position of the vehicle 2 with respect to the stop line 4. Then, the ECU 10 stores the three traveling parameters in the memory 8 together with the driver data recognized in step S101 (step S109).

When the ECU 10 determines in step S102 that the stop sign 3 present in front of the vehicle 2 is not recognized, the ECU 10 determines whether the red light or the yellow light of the traffic light (not shown) present in front of the vehicle 2 is recognized based on the image data of the camera 6 (step S110).

When the ECU 10 determines that the red light or the yellow light of the traffic light present in front of the vehicle 2 is recognized, the ECU 10 determines whether the vehicle speed of the vehicle 2 is equal to or less than the regulated speed based on the detection value of the vehicle speed sensor 7 (step S111). The regulated speed is, for example, 10 km/h. When the ECU 10 determines that the vehicle speed of the vehicle 2 is not equal to or less than the regulated speed, the ECU 10 executes step S101 again.

When the ECU 10 determines that the vehicle speed of the vehicle 2 is equal to or lower than the regulated speed, the ECU 10 records the time-series data of the vehicle speed of the vehicle 2 (step S112). Further, the ECU 10 calculates the distance from the vehicle 2 to the stop line corresponding to the traffic light based on the image data of the camera 6 (step S113). Then, the ECU 10 records the time-series data of the distance from the vehicle 2 to the stop line corresponding to the traffic light (step S114).

Subsequently, the ECU 10 executes step S101 again after executing the procedure S109 from step S107. When the ECU 10 determines in step S110 that the red light and the yellow light of the traffic light present in front of the vehicle 2 are not recognized, the ECU 10 executes step S101 again.

Here, the driver recognition unit 11 executes step S101. The target recognition unit 12 executes steps S102, S110. The distance calculation unit 13 executes step S105, S113. The time-series data extraction unit 14 executes steps S103, S104, S106, S111, S112, S114. The parameter calculation unit 15 executes steps S107, S108. The parameter storage unit 16 executes step S109.

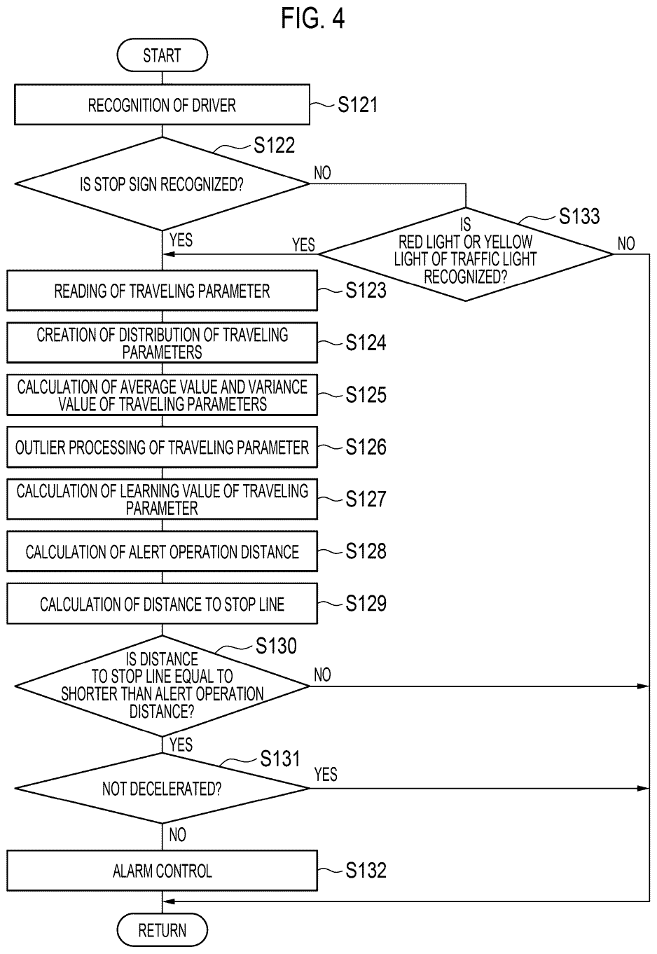

FIG. 4 is a flowchart showing a procedure of the alert control process executed by the ECU 10. The present process is executed by the driver recognition unit 11, the target recognition unit 12, the distance calculation unit 13, the learning processing unit 17, the operation distance calculation unit 18, the alert determination unit 19, and the alarm controller 20. The present process is executed in parallel to the parameter calculation process shown in FIG. 3.

In FIG. 4, the ECU 10 first recognizes the driver of the vehicle 2 based on the image data of the camera 5 (step S121). Next, the ECU 10 determines whether the stop sign 3 present in front of the vehicle 2 is recognized based on the image data of the camera 6 (step S122).

When the ECU 10 determines that the stop sign 3 present in front of the vehicle 2 is recognized, the ECU 10 reads the three traveling parameters corresponding to the driver of the vehicle 2 from the memory 8 (step S123). The traveling parameter is a deceleration of the vehicle 2, the minimum speed of the vehicle 2, and an offset amount of a stop position of the vehicle 2 with respect to a stop line 4 corresponding to the stop sign 3.

Then, the ECU 10 creates a distribution of each of the three traveling parameters (step S124). Next, the ECU 10 calculates an average value u and a variance σ² of the three traveling parameters, respectively (step S125).

Next, the ECU 10 performs an outlier processing of each of the three traveling parameters using the average value u and the variance σ² (step S126). For example, the ECU 10 excludes a value out of a range of (μ±σ) that is a value in a 1σ range as an outlier for each traveling parameter.

Next, the ECU 10 calculates a learning value of each of the three traveling parameters (step S127). For example, the ECU 10 sets an average value or a median value within a range of (μ±σ) as a learning value for each traveling parameter. The learning value of the traveling parameter is the deceleration g of the vehicle 2, the minimum speed vₘᵢₙ of the vehicle 2, and the offset amount a of the stop position of the vehicle 2 with respect to the stop line 4 (see FIG. 2).

Next, the ECU 10 calculates the alert operation distance D(v) with respect to the stop line 4 by using the following equation based on the detection value of the vehicle speed sensor 7 as shown in FIG. 2 (step S128). The alert operation distance D(v) is a distance corresponding to the vehicle speed of the vehicle 2. The reaction time Tis 1.

$$D ( v ) = vT + \frac{{( v - {v}_{min} )}^{2}}{2 g} + a$$

D(v)=coasting distance D1+braking distance D2+offset amount a

Subsequently, as shown in FIG. 2, the ECU 10 calculates the distance D_{driver} from the vehicle 2 to the stop line 4 based on the image data of the camera 6 (step S129). Then, the ECU 10 determines whether the distance D_{driver} from the vehicle 2 to the stop line 4 is equal to or shorter than the alert operation distance D(v) calculated in step S128 (step S130).

When the ECU 10 determines that the distance D_{driver} from the vehicle 2 to the stop line 4 is equal to or shorter than the alert operation distance D(v), the ECU 10 determines whether the vehicle 2 is being decelerated based on the detection value of the vehicle speed sensor 7 (step S131). When the ECU 10 determines that the vehicle 2 is not decelerated, the ECU 10 controls the alarm device 9 to issue the alert alarm (step S132), and executes the above step S121 again.

When the ECU 10 determines in step S130 that the distance D_{driver} from the vehicle 2 to the stop line 4 is not equal to or smaller than the alert operation distance D(v), or when the ECU 10 determines in step S131 that the vehicle 2 is being decelerated, the ECU 10 does not execute step S132 and executes step S121 again.

When the ECU 10 determines in step S122 that the stop sign 3 present in front of the vehicle 2 is not recognized, the ECU 10 determines whether the red light or the yellow light of the traffic light (not shown) present in front of the vehicle 2 is recognized based on the image data of the camera 6 (step S133).

When a determination is made that the red light or the yellow light of the traffic light present in front of the vehicle 2 is recognized, the ECU 10 executes step S123 and the subsequent procedures. In this case, the stop line is a stop line corresponding to the traffic light. When the ECU 10 determines that the red light and the yellow light of the traffic light present in front of the vehicle 2 are not recognized, the ECU 10 executes step S121 again without executing step S123 and after.

Here, the driver recognition unit 11 executes step S121. The target recognition unit 12 executes steps S122, S133. The distance calculation unit 13 executes step S129. The learning processing unit 17 executes steps S123 to S127. The operation distance calculation unit 18 executes step S128. The alert determination unit 19 executes steps S130, S131. The alarm controller 20 executes step S132.

In the alert device 1 as described above, as shown in FIG. 2, the stop sign 3 present in front of the vehicle 2 is recognized by the camera 6. As a result, when the deceleration of the vehicle 2 is started, the time-series data of the vehicle speed of the vehicle 2 until the vehicle 2 reaches the minimum speed of the vehicle 2 and the time-series data of the distance from the vehicle 2 to the stop line 4 corresponding to the stop sign 3 are extracted. Then, as the traveling parameter, the deceleration of the vehicle 2, the minimum speed of the vehicle 2, and the offset amount of the stop position of the vehicle 2 with respect to the stop line 4 are calculated based on the time-series data of the vehicle speed and the distance. The traveling parameter is associated with the driver of the vehicle 2 recognized by the camera 5 and stored in the memory 8.

Thereafter, when the vehicle 2 approaches the stop sign 3, the distribution of the traveling parameters of the driver stored in the memory 8 is created, and the traveling parameter learning process is performed. Then, the alert operation distance D(v) to the stop line 4 is calculated based on the deceleration g of the vehicle 2, the minimum speed vₘᵢₙ of the vehicle 2, and the offset amount a of the stop position of the vehicle 2 with respect to the stop line 4.

Thereafter, when the distance D_{driver} from the vehicle 2 to the stop line 4 is equal to or shorter than the alert operation distance D(v), determination is made whether the vehicle 2 is being decelerated. The alert is issued by the alarm device 9 to the driver, even when the distance D_{driver} from the vehicle 2 to the stop line 4 is equal to or shorter than the alert operation distance D(v) and the driver does not depress the brake pedal, and thus the vehicle 2 is not decelerated. Therefore, the driver can stop the vehicle 2 in front of the stop line 4 by depressing the brake pedal.

The red light or the yellow light of the traffic light present in front of the vehicle 2 is recognized by the camera 6. As a result, when the deceleration of the vehicle 2 is started, the time-series data of the vehicle speed of the vehicle 2 until the vehicle 2 reaches the minimum speed of the vehicle 2 and the time-series data of the distance from the vehicle 2 to the stop line corresponding to the traffic light are extracted. Then, in the same manner as described above, as the traveling parameter, the deceleration of the vehicle 2, the minimum speed of the vehicle 2, and the offset amount of the stop position of the vehicle 2 with respect to the stop line are calculated.

Thereafter, when the vehicle 2 approaches the traffic light, in the same manner as described above, the learning process of the traveling parameter is performed, and the alert operation distance D(v) with respect to the stop line is calculated. Then, the alert is issued by the alarm device 9 to the driver in the same manner as described above, even when the distance D_{driver} from the vehicle 2 to the stop line is equal to or shorter than the alert operation distance D(v) and the vehicle 2 is not decelerated.

As described above, in the present embodiment, any of the stop sign 3 and the red light or the yellow light of the traffic light (not shown) present in the traveling direction of the vehicle 2 is detected, the information related to the driving tendency of the driver of the vehicle 2 with respect to any of the stop sign 3 and the red light or the yellow light of the traffic light is acquired. Then, the timing of issuing the alert to the driver is controlled by using the information related to the driving tendency of the driver. Therefore, the timing for issuing the alert to the driver is changed according to the driving tendency of the driver. As a result, it is possible to issue an alert to the driver of the vehicle 2 without causing annoyance to a driver of a vehicle.

Further, in the embodiment, the parameter related to the traveling state of the vehicle 2 when the vehicle 2 is being brought to a stop at the stop sign 3 or the stop line corresponding to the traffic light is calculated based on the information related to the driving tendency, and the alert operation distance D(v) with respect to the stop line is calculated based on the parameter relating to the traveling state of the vehicle 2. Then, when determination is made that the distance D_{driver} from the vehicle 2 to the stop line is equal to or shorter than the alert operation distance D(v), the control is performed to issue the alert. In this way, when the distance D_{driver} from the vehicle 2 to the stop line is equal to or shorter than the alert operation distance D(v) with respect to the stop line, the alert is issued. Therefore, it is possible to issue the alert in front of the stop line.

Further, in the present embodiment, when the determination is made that the distance D_{driver} from the vehicle 2 to the stop line is equal to or shorter than the alert operation distance D(v) and the vehicle 2 is being decelerated, the control is performed to issue the alert. Even when the distance D_{driver} from the vehicle 2 to the stop line is equal to or shorter than the alert operation distance D(v), the alert is issued in a case where the vehicle 2 is not decelerated. Therefore, for example, even when the vehicle 2 travels toward the stop line in a state in which the driver does not operate the brake, the alert can be issued in front of the stop line.

In the present embodiment, as the information related to the driving tendency, the time-series data of the vehicle speed of the vehicle 2 and the time-series data of the distance from the vehicle 2 to the stop line are acquired. As a parameter related to the traveling state of the vehicle 2, the deceleration of the vehicle 2 when the vehicle 2 is being brought to a stop, the minimum speed of the vehicle 2, and the offset amount of the stop position of the vehicle 2 with respect to the stop line are calculated. Therefore, when the vehicle 2 is being brought to a stop at the stop sign 3 or the traffic light, it is possible to issue an alert at a timing suitable for the deceleration action of the vehicle 2 by the driver.

In the present embodiment, the driver of the vehicle 2 is recognized, and the alert operation distance D(v) according to the driver is calculated. Therefore, even when a plurality of drivers drives the same vehicle 2, it is possible to issue the alert at the timing corresponding to the deceleration action of the vehicle 2 by each driver when the vehicle 2 is being brought to a stop at the stop sign 3 or the traffic light.

The present disclosure is not limited to the above-described embodiments.

For example, in the above-described embodiment, the minimum speed that is one of the parameters related to the traveling state of the vehicle 2, is set to zero, but the present disclosure is not limited to such a form. For example, when the vehicle 2 travels toward the traffic light, even when the red light of the traffic light is detected, the traffic light is switched from the red light to the green signal before the vehicle 2 reaches the traffic light, and the vehicle 2 passes the traffic light without stopping at the stop line corresponding to the traffic light. Therefore, the minimum speed may be set to a value greater than zero.

Further, in the above-described embodiment, the alert is issued to the driver even when the distance D_{driver} from the vehicle 2 to the stop line is equal to or shorter than the alert operation distance D(v) and the vehicle 2 is not decelerated. However, the present disclosure is not limited to such a form. For example, the alert is issued to the driver at the time when the distance D_{driver} from the vehicle 2 to the stop line is equal to or shorter than the alert operation distance D(v) regardless of whether the vehicle 2 is being decelerated.

In the above-described embodiment, the determination is made whether the vehicle 2 is being decelerated based on the detection value of the vehicle speed sensor 7. However, the present disclosure is not limited to the above-described embodiment, and for example, the determination may be made whether the vehicle 2 is being decelerated based on the depression amount of the brake pedal and the accelerator pedal.

In the above-described embodiment, the distance from the vehicle 2 to the stop sign 3 or the stop line corresponding to the traffic light is calculated based on the image data of the camera 6. However, the present disclosure is not limited to the above-described embodiment, and for example, the distance from the vehicle 2 to the stop line may be detected based on the detection data of a distance measurement sensor, such as a LiDAR.

1. An alert device that issues an alert to a driver of a vehicle that the vehicle needs to be stopped, the alert device comprising:
a target detection unit configured to detect at least one of a stop sign and a red light or a yellow light of a traffic light present in a traveling direction of the vehicle;
an acquisition unit configured to acquire information related to a driving tendency of the driver with respect to the at least one of the stop sign and the red light or the yellow light of the traffic light detected by the target detection unit; and
a controller configured to control a timing of issuing the alert by using the information related to the driving tendency acquired by the acquisition unit.

2. The alert device according to claim 1, further comprising:
a distance detection unit configured to detect a distance from the vehicle to a stop line corresponding to the at least one of the stop sign and the traffic light;
a first calculation unit configured to calculate a parameter related to a traveling state of the vehicle when the vehicle is being brought to a stop at the stop line, based on the information related to the driving tendency acquired by the acquisition unit;
a second calculation unit configured to calculate an alert operation distance with respect to the stop line based on the parameter related to the traveling state of the vehicle calculated by the first calculation unit; and
a determination unit configured to determine whether the distance to the stop line detected by the distance detection unit is equal to or shorter than the alert operation distance calculated by the second calculation unit,
wherein the controller is configured to perform control to issue the alert when the determination unit determines that the distance to the stop line is equal to or shorter than the alert operation distance.

3. The alert device according to claim 2, wherein:
the determination unit is configured to determine whether the distance to the stop line is equal to or shorter than the alert operation distance and the vehicle is being decelerated; and
the controller is configured to perform the control to issue the alert when the determination unit determines that the distance to the stop line is equal to or shorter than the alert operation distance and the vehicle is being decelerated.

4. The alert device according to claim 2, further comprising a vehicle speed detection unit configured to detect a vehicle speed of the vehicle, wherein:
the acquisition unit is configured to acquire, as the information related to the driving tendency, time-series data of the vehicle speed detected by the vehicle speed detection unit and time-series data of the distance to the stop line that is detected by the distance detection unit; and
the first calculation unit is configured to calculate, as the parameter related to the traveling state of the vehicle, a deceleration of the vehicle when the vehicle is being brought to a stop, a minimum speed of the vehicle, and an offset amount of a stop position of the vehicle with respect to the stop line.

5. The alert device according to claim 2, further comprising a recognition unit configured to recognize the driver, wherein the second calculation unit is configured to calculate the alert operation distance according to the driver recognized by the recognition unit.
